(19) United States
(12) Patent Application Publication
(10) Pub. No.: US 2021/0191475 A1
(43) Pub. Date: Jun. 24, 2021

(54) IN-FOLDING TYPE HINGE STRUCTURE HAVING FLEXIBLE DISPLAY PANEL INSTALLED THEREIN

(71) Applicant: AUFLEX CO., LTD., Hwaseong-si (KR)

(72) Inventors: Hyun Min PARK, Suwon-si (KR); Seoung Jun LEE, Uiwang-si (KR)

(21) Appl. No.: 16/768,311

(22) PCT Filed: Dec. 3, 2018
(86) PCT No.: PCT/KR2018/015211

§ 371 Date: May 29, 2020

(30) Foreign Application Priority Data
Dec. 4, 2017 (KR) 10-2017-0165509
Dec. 7, 2017 (KR) 10-2017-0167859

(51) Int. Cl. G06F 1/16

(52) U.S. Cl. CPC G06F 1/1681; G06F 1/1652

(57) ABSTRACT

Provided is an in-folding type hinge structure having a flexible display panel installed therein in which a plurality of rotation supports are provided in a central joint that connects two body portions and two sliding panels sliding in the respective body portions together, and the rotation supports are directly connected to the two body portions to support rotation of the body portions such that the body portions do not rotate over 180 degrees when the two body portions are fully unfolded, whereby damage of the flexible display panel provided on the surfaces of the two body portions can be prevented.

### TECHNICAL FIELD

The invention relates to an in-folding type hinge structure having a flexible display panel installed therein and, more particularly, to an in-folding type hinge structure having a flexible display panel installed therein in which a plurality of rotation supports are provided in a central joint that connects two body portions and two sliding panels sliding in the respective body portions together in a mobile communication terminal in which a flexible display panel is provided in the two body portions which are foldably connected to each other, and the rotation supports are directly connected to the two body portions to support rotation of the body portions such that the body portions do not rotate over 180 degrees when the two body portions are fully unfolded, whereby damage of the flexible display panel provided on the surfaces of the two body portions can be prevented.

### BACKGROUND ART

Mobile communication terminals are configured to perform various functions. Examples of the functions include a data and speech communication function, a function of capturing a still image or a moving image using a camera, a speech storing function, a function of reproducing a music file using a speaker system, and a function of displaying a still image or a moving image (a video).

Some mobile communication terminals have additional functions for playing games, and some mobile communication terminals are embodied as multimedia devices. Recent mobile communication terminals can also receive broadcast or multicast signals and reproduce a video or a television program.

Researches for supporting and improving other functions of mobile communication terminals in addition to the above-mentioned functions have been carried out. These researches include modification and improvement of structural constituents of the mobile communication terminals and addition and improvement of software or hardware.

In general, a display module of a mobile communication terminal displays information which is processed by the mobile communication terminal. For example, when the mobile communication terminal is in a call mode, the display module displays a user interface (UI) or a graphic user interface (GUI) associated with a call.

When the mobile communication terminal is in a video call mode or an image capturing mode, the display module displays a captured or/and received image, a UI, or a GUI. The display module includes a liquid crystal display, a thin-film transistor liquid crystal display, an organic light emitting diode, a flexible display, or a 3D display.

A flexible display (or a flexible LCD) has been regularly researched with its merit of deformability. It takes much time to use a rolled display like a paper roll as shown in science-fiction movie.

Therefore, transitional forms of flexible displays will be many used until the flexible displays are regularly used with sufficient development thereof, and these transitional forms will be similar to current structures of communication terminals. Accordingly, there is necessity for description of usage and protection of flexible displays when such flexible displays are used in mobile communication terminals.

### CITATION LIST

### Patent Literature

An example of a hinge structure for a mobile communication terminal having a flexible display panel installed therein is disclosed in Korean Patent Application Laid-open No. 10-2015-0096827 (Title of the Invention: HINGE STRUCTURE AND FOLDABLE DISPLAY DEVICE INCLUDING THE SAME).

### SUMMARY OF THE INVENTION

### Technical Problem

The invention provides an in-folding type hinge structure having a flexible display panel installed therein in which a plurality of rotation supports are provided in a central joint that connects two body portions and two sliding panels sliding in the respective body portions together, and the rotation supports are directly connected to the two body portions to support rotation of the body portions such that the body portions do not rotate over 180 degrees when the two body portions are fully unfolded, whereby damage of the flexible display panel provided on the surfaces of the two body portions can be prevented.

### Solution to Problem

In order to achieve the above-mentioned objective, there is provided an in-folding type hinge structure having a flexible display panel installed therein. The in-folding type hinge structure includes: a panel portion in which the flexible display panel is installed, a joint portion (141) including a plurality of joints are formed in a central part thereof, and panels (112) are installed on both sides of the joint portion (141); outer cases (110) in which the panels (112) of the panel portion are accommodated; and sliders (121) that are rotatably coupled to an intermediate part between the panels (112), wherein the sliders (121) are accommodated in slider accommodation portions (124) in the outer cases and slide while the panels (112) are being folded or unfolded, and wherein a central joint (150) which is completely assembled is installed at the center of a bottom surface of the panels (112) and is rotatably coupled to the sliders (121) by a connection pin (143).

Rotation supports (52) and sub hinge plates (155) may be rotatably connected to a rear part of the central joint (150) and a first extension mount (151) may be installed in a front part thereof.

The rotation supports (52) may be connected to the first extension mount to be rotatable with the main hinge plates (153), symmetric supports (162) may be connected to front and rear surfaces of the rotation supports (52), and the rotation supports (52) and the symmetric supports (162) may include connecting intermediate portions which are gears engaging with each other and be configured to rotate simultaneously in opposite directions in rotation.

Rotation guide grooves (164) may be formed in a front part of the central joint (150.

Rotation guide protrusions (166) may be formed in the main hinge plates (153) and the rotation guide protrusions (166) may be inserted into the rotation guide grooves (164) such that the rotation guide protrusions (166) move along the rotation guide grooves (164).

A movement trajectory of the main hinge plates (153) may be formed along the rotation guide grooves (164).

Rotation guide grooves (164) may be formed in a rear surface of a second extension support (152) and rotation guide protrusions (166) formed in a front part of the main hinge plates (153) are inserted into the rotation guide grooves (164) such that the rotation guide protrusions (166) move, and the rotation supports (52) connected to the sub hinge plates (155) may include connecting portions which are gears engaging with each other such that the rotation supports (52) move in the opposite directions at the time of rotation.

### Advantageous Effects of Invention

According to the invention, it is possible to provide an in-folding type hinge structure having a flexible display panel installed therein in which a plurality of rotation supports are provided in a central joint that connects two body portions and two sliding panels sliding in the respective body portions together, and the rotation supports are directly connected to the two body portions to support rotation of the body portions such that the body portions do not rotate over 180 degrees when the two body portions are fully unfolded, whereby damage of the flexible display panel provided on the surfaces of the two body portions can be prevented.

### BRIEF DESCRIPTION OF THE DRAWINGS

FIG. 1 is an exploded perspective view of an in-folding type hinge structure having a flexible display panel installed therein according to the invention.

FIG. 2 is an exploded perspective view of a central joint illustrated in FIG. 1.

FIG. 3 is an exploded perspective view of a rear side of the in-folding type hinge structure having a flexible display panel installed therein according to the invention illustrated in FIG. 1.

FIG. 4 is an exploded perspective view of the central joint illustrated in FIG. 3.

FIG. 5 is a plan view and a front view of the in-folding type hinge structure having a flexible display panel installed therein according to the invention.

FIG. 6 is a rear view and a side view of the in-folding type hinge structure having a flexible display panel installed therein according to the invention.

FIG. 7 is a sectional view taken along line A-A′ in FIG. 6 in a state in which the in-folding type hinge structure having a flexible display panel installed therein according to the invention is folded.

FIG. 8 is a sectional view of a joint portion taken along line A-A′ in FIG. 6 in a state in which the in-folding type hinge structure having a flexible display panel installed therein according to the invention is being unfolded.

FIG. 9 is a sectional view of the joint portion taken along line A-A′ in FIG. 6 in a state in which the in-folding type hinge structure having a flexible display panel installed therein according to the invention is fully unfolded.

FIG. 10 is a sectional view of a central joint and one body portion taken along line A-A′ in FIG. 6 in a state in which the in-folding type hinge structure having a flexible display panel installed therein according to the invention is fully unfolded.

FIG. 11 is a partially enlarged sectional view of the central joint illustrated in FIG. 10.

FIG. 12 is a sectional view of the central joint in a state in which one body portion is being folded according to the invention.

FIG. 13 is a sectional view of the central joint in a state in which one body portion is fully folded according to the invention.

FIG. 14 is a first exploded perspective view of an in-folding type hinge structure having a flexible display panel installed therein according to another embodiment of the invention.

FIG. 15 is a second exploded perspective view of the in-folding type hinge structure having a flexible display panel installed therein according to another embodiment of the invention.

FIG. 16 is a third exploded perspective view of the in-folding type hinge structure having a flexible display panel installed therein according to another embodiment of the invention.

FIG. 17 is a perspective view illustrating a state in which a central joint portion of an in-folding type hinge structure according to another embodiment of the invention has been assembled.

FIG. 18 is a first exploded perspective view illustrating a state in which the central joint portion of the in-folding type hinge structure according to another embodiment of the invention has been disassembled.

FIG. 19 is a second exploded perspective view illustrating a state in which the central joint portion of the in-folding type hinge structure according to another embodiment of the invention has been disassembled.

FIG. 20 is a third exploded perspective view illustrating a state in which the central joint portion of the in-folding type hinge structure according to another embodiment of the invention has been disassembled.

FIG. 21 is an enlarged perspective view of a front part in FIG. 20.

FIG. 22 is a perspective view illustrating a state in which main hinge plates and sub hinge plates coupled to a central joint of the in-folding type hinge structure according to another embodiment of the invention are fully unfolded.

FIG. 23 is a perspective view illustrating a state in which the main hinge plates and the sub hinge plates coupled to the central joint of the in-folding type hinge structure according to another embodiment of the invention start folding in a state in which they are fully unfolded.

FIG. 24 is a perspective view illustrating a state in which the main hinge plates and the sub hinge plates coupled to the central joint of the in-folding type hinge structure according to another embodiment of the invention are folded by about 90 degrees.

FIG. 25 is a perspective view illustrating a state in which the main hinge plates and the sub hinge plates coupled to a central joint of the in-folding type hinge structure according to another embodiment of the invention are fully folded.

FIG. 26 is a perspective view illustrating shapes of rotation guide grooves which are formed in a front surface of the central joint of the in-folding type hinge structure according to another embodiment of the invention.

FIG. 27 is a front view illustrating a state in which rotation guide protrusions of the main hinge plates are inserted into the rotation guide grooves formed in the front surface of the central joint in the state in which the main hinge plates is fully folded at the central joint in the in-folding type hinge structure according to another embodiment of the invention.

FIG. 28 is a front view illustrating a state in which the rotation guide protrusions of the main hinge plates move in the rotation guide grooves formed in the front surface of the central joint while the main hinge plates are being unfolded in the in-folding type hinge structure according to another embodiment of the invention.

FIG. 29 is a front view illustrating a state in which rotation supports connected to the central joint support the main hinge plates in the state in which the main hinge plates are fully folded at the central joint in the in-folding type hinge structure according to another embodiment of the invention.

FIG. 30 is a front view illustrating a state in which the rotation supports connected to the central joint move while the main hinge plates are being unfolded in the in-folding type hinge structure according to another embodiment of the invention.

FIG. 31 is a front view illustrating a state in which reinforcement supports connected to the central joint supports the main hinge plates such that the main hinge plates are symmetric in angle in the state in which the main hinge plates are fully folded at the central joint in the in-folding type hinge structure according to another embodiment of the invention.

FIG. 32 is a front view illustrating a state in which the reinforcement supports connected to the central joint supports the main hinge plates such that the main hinge plates are symmetric in angle while the main hinge plates are being unfolded in the in-folding type hinge structure according to another embodiment of the invention.

FIG. 33 is a perspective view illustrating a state in which a flexible display panel is installed on a top surface of the in-folding type hinge structure having the flexible display panel installed therein according to another embodiment of the invention.

### DESCRIPTION OF EMBODIMENTS

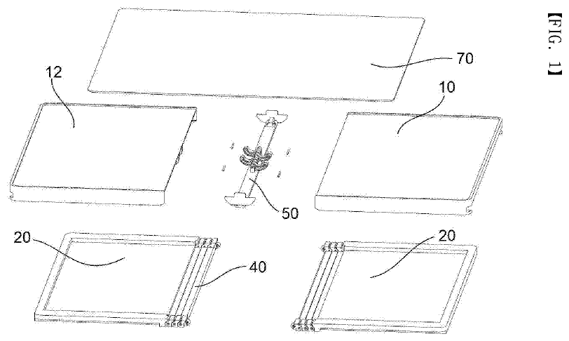

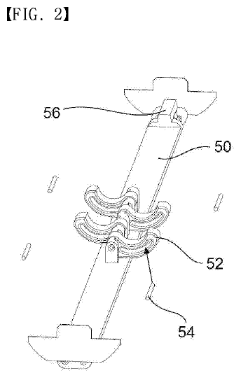

FIG. 1 is an exploded perspective view of an in-folding type hinge structure having a flexible display panel installed therein according to the invention. FIG. 2 is an exploded perspective view of a central joint illustrated in FIG. 1.

Referring to FIGS. 1 and 2, in an in-folding type hinge structure having a flexible display panel installed therein according to the invention, two body portions 10 and 12 opposing each other are provided, and a central joint 50 is provided between the body portions 10 and 12 and is rotatably connected to the two body portions 10 and 12.

Sliding panels 20 are provided in the two body portions 10 and 12 in the invention such that the sliding panels 20 can slide in the respective body portions 10 and 12.

A joint portion 40 in which a plurality of joints are connected to each other is provided on each of the opposing surfaces of the sliding panels 20, and the joint portions 40 are rotatably connected to the central joint 50.

Two rotation supports 52 are rotatably provided on each side of the central joint 50, and a guide groove 53 into which a rivet 54 is inserted and moves is formed in each rotation support 52.

The rotation supports 52 are rotatably coupled to the central joint 50.

A gap providing portion 56 that forms a gap between the two body portions 10 and 12 when the body portions 10 and 12 are fully folded is formed at both ends of the central joint 50.

A flexible display panel 70 according to the invention is attached to the surfaces of the two body portions 10 and 12 in a state in which the body portions 10 and 12 and the sliding panels 20 are all coupled to the central joint 50.

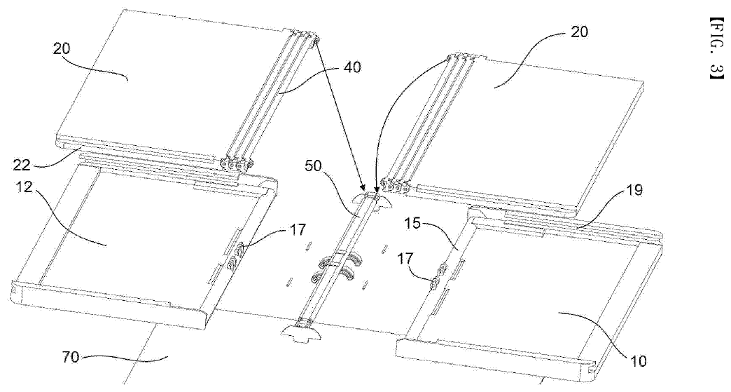

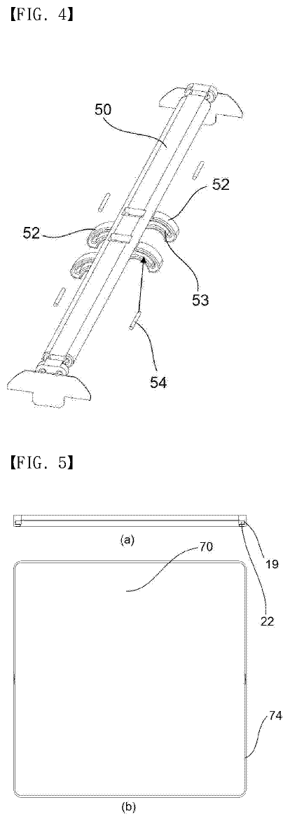

FIG. 3 is an exploded perspective view of a rear side of the in-folding type hinge structure having a flexible display panel installed therein according to the invention illustrated in FIG. 1. FIG. 4 is an exploded perspective view of the central joint illustrated in FIG. 3.

Referring to FIGS. 3 and 4, a guide protrusion 22 is formed on two opposing side surfaces of each sliding panel 20 according to the invention, and a guide groove 19 into which the corresponding guide protrusion 22 is inserted and moves is formed on the inner side surfaces of the two body portions 10 and 12.

A rounded contact surface 15 is formed on the opposing surfaces of the two body portions 10 and 12, and a rivet fixing portion 17 to which a rivet 54 inserted into the guide groove 53 of the rotation supports 52 is fixed is formed in the middle of the rounded contact surface 15.

Both ends of each joint portion 40 are rotatably coupled to both ends of the central joint 50. This coupling is indicated by an arrow. The other end of the joint portion 40 which is not indicated by an arrow is also rotatably coupled to the other end of the central joint 50.

The central joint 50 is rotatably coupled to the two body portions 10 and 12 and is also rotatably coupled to fronts of the joint portions 40 of the two sliding panels 20.

A stopping area having a slightly recessed shape in which ends of the rotation supports 52 according to the invention are received can be formed close to the contact surfaces 15 of the body portions 10 and 12. The stopping area may be required or may not be required depending on the shapes of the rotation supports 52 and the contact surfaces 15.

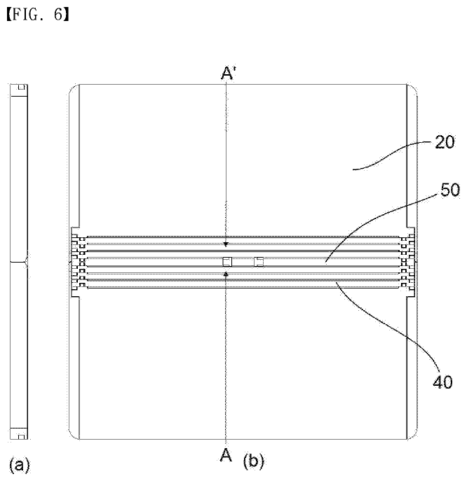

FIG. 5 is a plan view and a front view of the in-folding type hinge structure having a flexible display panel installed therein according to the invention.

Referring to FIG. 5, when the flexible display panel 70 is installed in the in-folding type hinge structure having a flexible display panel installed therein according to the invention, a width of a bezel 74 can be reduced.

In the in-folding type hinge structure having a flexible display panel installed therein according to the invention, since the central joint 50 and the rotation supports 52 rotatably coupled to the central joint 50 support the two body portions 10 and 12, lateral areas of the body portions 10 and 12 do not need to be formed large and thus the width of the bezel 74 can be reduced.

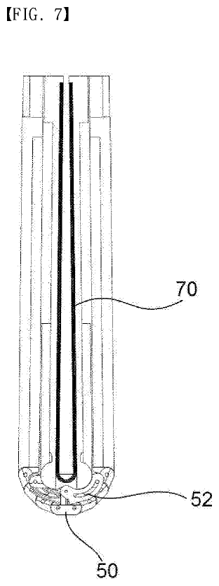

FIG. 6 is a rear view and a side view of the in-folding type hinge structure having a flexible display panel installed therein according to the invention.

Referring to FIG. 6, the central joint 50 according to the invention is rotatably coupled to joints of the joint portion 40 that is connected to the two sliding panels 20.

The guide protrusions 22 of the sliding panels 20 according to the invention are inserted into the guide grooves 19 in the body portions 10 and 12 so as to move therein.

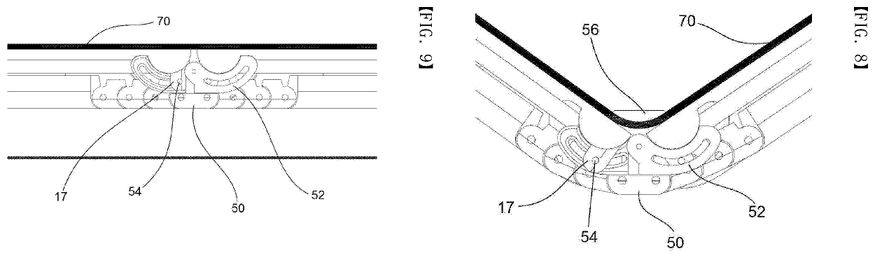

FIG. 7 is a sectional view taken along line A-A′ in FIG. 6 in a state in which the in-folding type hinge structure having a flexible display panel installed therein according to the invention is folded.

Referring to FIG. 7, in the state in which the two body portions 10 and 12 are fully folded, a gap with a predetermined length is formed in a folded part of the flexible display panel 70 due to the gap providing portion 56 formed in the central joint 50.

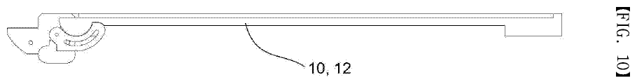

FIG. 8 is a sectional view of a joint portion taken along line A-A′ in FIG. 6 in a state in which the in-folding type hinge structure having a flexible display panel installed therein according to the invention is being unfolded.

Referring to FIG. 8, the central joint 50 is rotatably connected to the joint portions 40, and the rotation supports 52 of the central joint 50 are rotated and supported along the guide grooves 53 of the rotation supports 52 by the rivet fixing portions 17 of the body portions 10 and 12 and the rivets 54.

In the state in which the two body portions 10 and 12 are fully folded, the surfaces of the two body portions 10 and 12 are not in close contact with each other but forms a gap with a predetermined length due to the gap providing portion 56 according to the invention.

FIG. 9 is a sectional view of the joint portion taken along line A-A′ in FIG. 6 in a state in which the in-folding type hinge structure having a flexible display panel installed therein according to the invention is fully unfolded.

Referring to FIG. 9, the rotation supports 52 of the central joint 50 rotate in contact with the rounded contact surfaces 15 and the two body portions 10 and 12 are unfolded.

In the state in which the two body portions 10 and 12 are fully unfolded, the rotation supports 52 are in contact with the inner surfaces of the body portions 10 and 12 such that the body portions 10 and 12 is strongly prevented from rotating over 180 degrees, whereby it is possible to prevent damage of the flexible display panel 70.

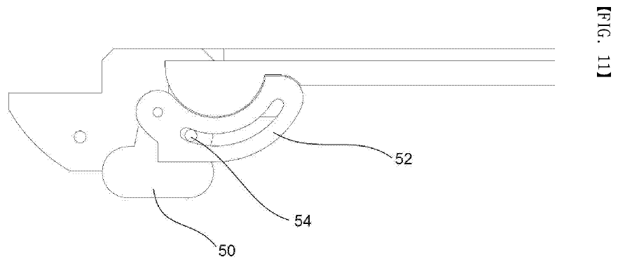

FIG. 10 is a sectional view of a central joint and one body portion taken along line A-A′ in FIG. 6 in a state in which the in-folding type hinge structure having a flexible display panel installed therein according to the invention is fully unfolded. FIG. 11 is a partially enlarged sectional view of the central joint illustrated in FIG. 10.

Referring to FIGS. 10 and 11, the central joint 50 and the rotation supports 52 according to the invention prevent the two body portions 10 and 12 from rotating out of a predetermined range.

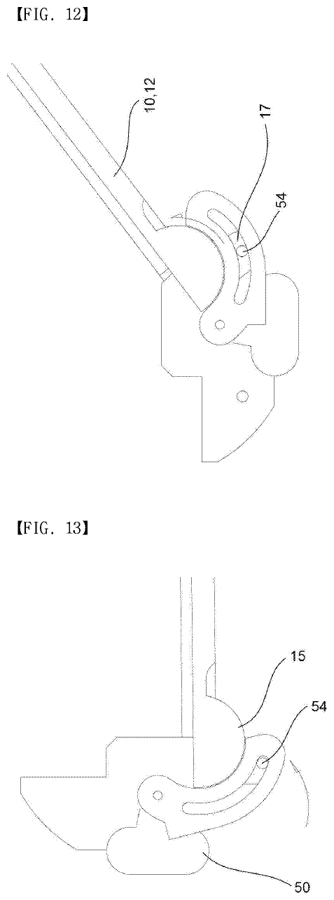

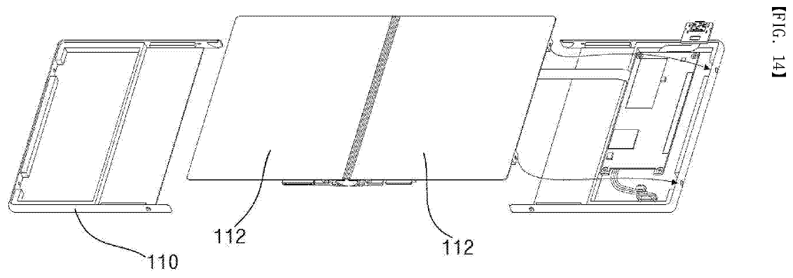

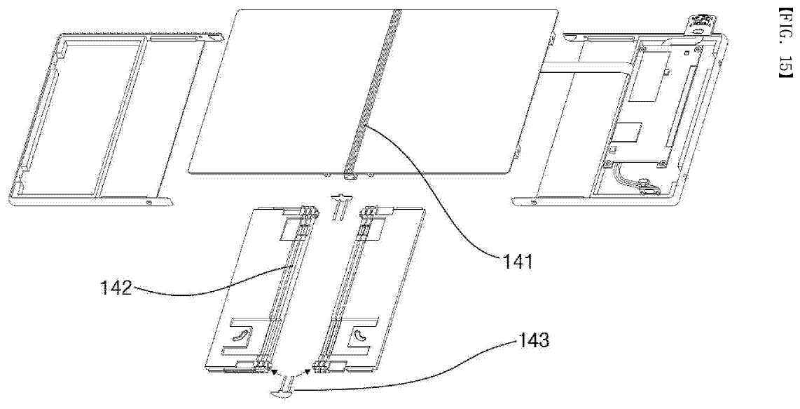

FIG. 12 is a sectional view of the central joint in a state in which one body portion is being folded according to the invention. FIG. 13 is a sectional view of the central joint in a state in which one body portion is fully folded according to the invention.

Referring to FIGS. 12 and 13, while the two body portions 10 and 12 are rotating about the central joint 50, the rivet fixing portions 17 having the rivets 54 coupled thereto and the body portions 10 and 12 rotate along the guide grooves 53 of the rotation supports 52.

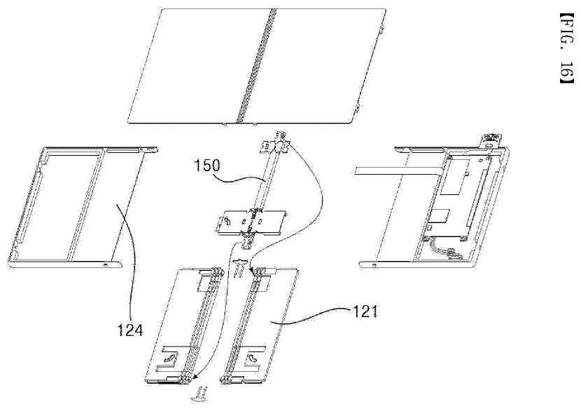

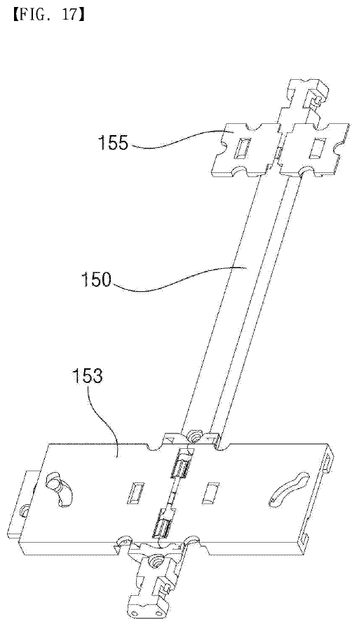

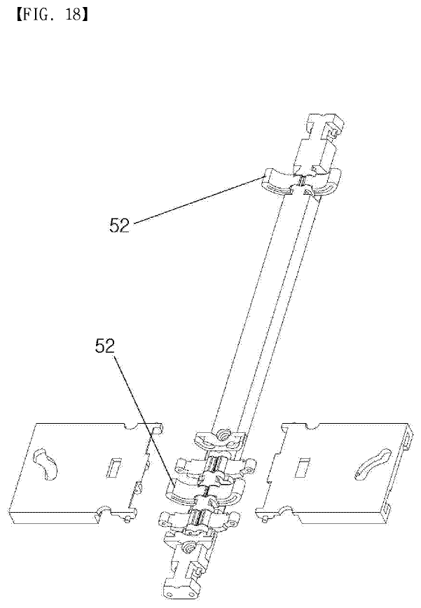

FIG. 14 is a first exploded perspective view of an in-folding type hinge structure having a flexible display panel installed therein according to another embodiment of the invention. FIG. 15 is a second exploded perspective view of the in-folding type hinge structure having a flexible display panel installed therein according to another embodiment of the invention. FIG. 16 is a third exploded perspective view of the in-folding type hinge structure having a flexible display panel installed therein according to another embodiment of the invention.

Referring to FIGS. 14 to 16, an in-folding type hinge structure having a flexible display panel installed therein according to another embodiment of the invention includes: a panel portion in which the flexible display panel is installed, a joint portion 141 including a plurality of joints are formed in a central part thereof, and panels 112 are installed on both sides of the joint portion 141; outer cases 110 in which the panels 112 of the panel portion are accommodated; and sliders 121 that are rotatably coupled to an intermediate part between the panels 112. The sliders 121 are accommodated in slider accommodation portions 124 in the outer cases and slide while the panels 112 are being folded or unfolded. A central joint 150 which is completely assembled is installed at the center of a bottom surface of the panels 112 and is rotatably coupled to the sliders 121 by a connection pin 143.

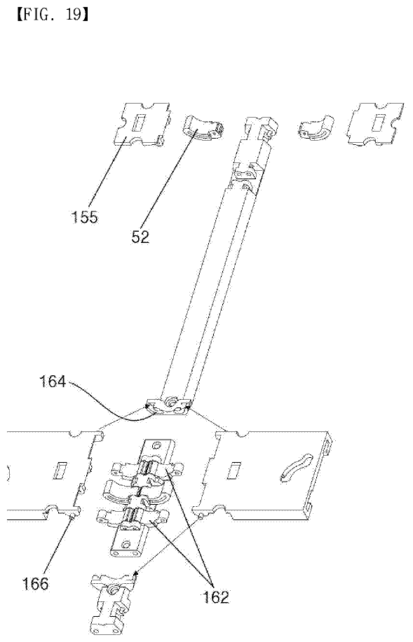

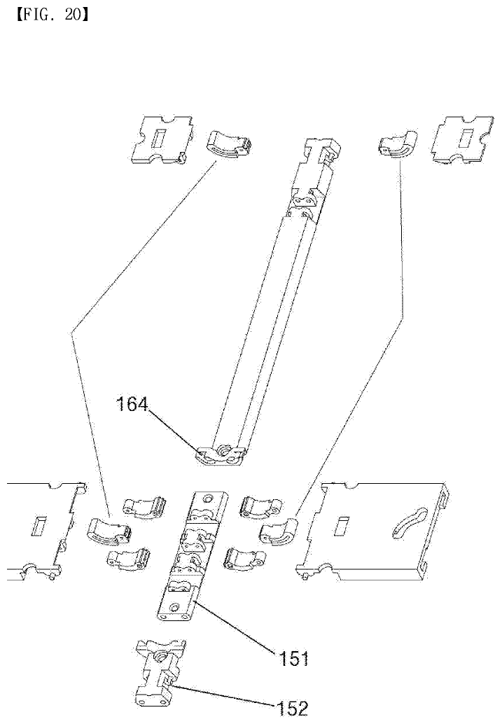

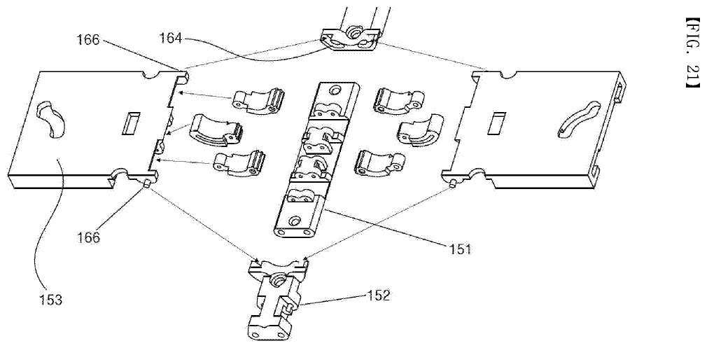

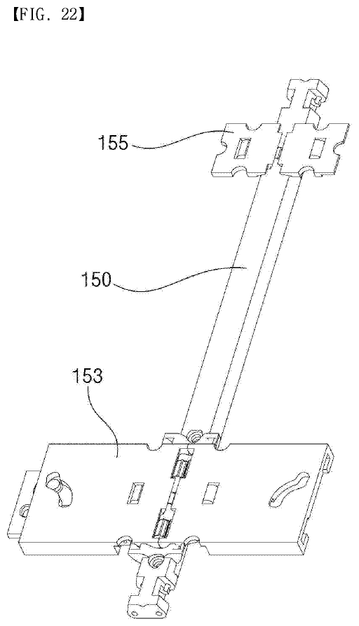

FIG. 17 is a perspective view illustrating a state in which the central joint portion of the in-folding type hinge structure according to another embodiment of the invention has been assembled. FIG. 18 is a first exploded perspective view illustrating a state in which the central joint portion of the in-folding type hinge structure according to another embodiment of the invention has been disassembled. FIG. 19 is a second exploded perspective view illustrating a state in which the central joint portion of the in-folding type hinge structure according to another embodiment of the invention has been disassembled. FIG. 20 is a third exploded perspective view illustrating a state in which the central joint portion of the in-folding type hinge structure according to another embodiment of the invention has been disassembled. FIG. 21 is an enlarged perspective view of the front part in FIG. 20.

Referring to FIGS. 17 and 21, rotation supports 52 and sub hinge plates 155 are rotatably connected to a rear part of the central joint 150 and a first extension mount 151 is installed in a front part thereof. The rotation supports 52 are connected to the first extension mount to be rotatable along with the main hinge plates 153. Symmetric supports 162 are connected to front and rear surfaces of the rotation supports 52.

According to the invention, the rotation supports 52 and the symmetric supports 162 include connecting intermediate portions which are gears engaging with each other and are configured to rotate simultaneously in opposite directions in rotation.

According to the invention, rotation guide grooves 164 are formed in a front part of the central joint 150. Rotation guide protrusions 166 are formed in the main hinge plates 153 and the rotation guide protrusions 166 are inserted into the rotation guide grooves 164 such that the rotation guide protrusions 166 move along the rotation guide grooves 164. A movement trajectory of the main hinge plates 153 is formed along the rotation guide grooves 164.

According to the invention, rotation guide grooves 164 are also formed in a rear surface of a second extension support 152 and rotation guide protrusions 166 formed in a front part of the main hinge plates 153 are inserted into the rotation guide grooves 164 such that the rotation guide protrusions 166 move.

According to the invention, the rotation supports 52 connected to the sub hinge plates 155 include connecting portions which are gears engaging with each other such that the rotation supports 52 move in the opposite directions at the time of rotation.

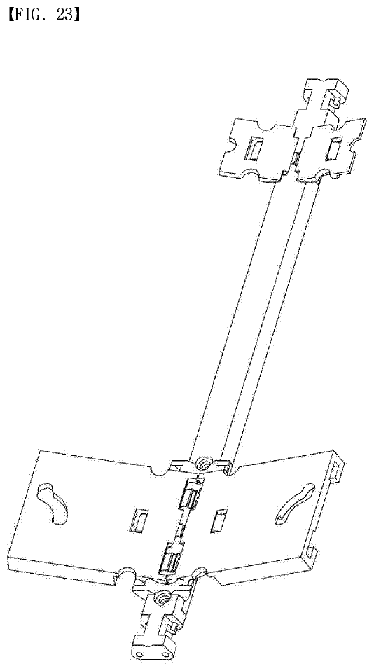

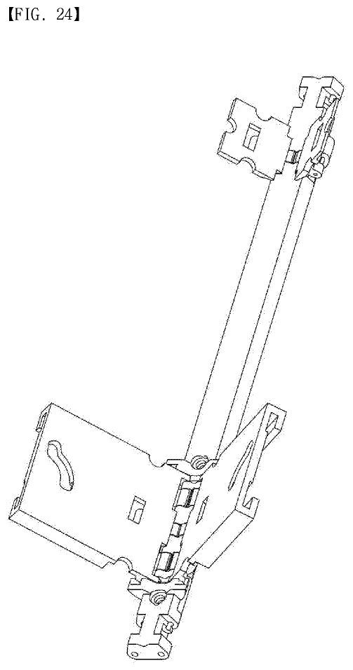

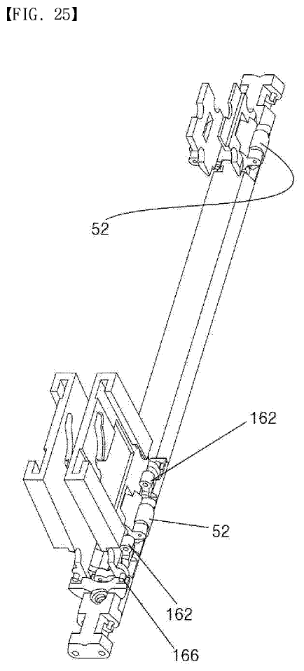

FIG. 22 is a perspective view illustrating a state in which the main hinge plates and the sub hinge plates coupled to the central joint of the in-folding type hinge structure according to another embodiment of the invention are fully unfolded. FIG. 23 is a perspective view illustrating a state in which the main hinge plates and the sub hinge plates coupled to the central joint of the in-folding type hinge structure according to another embodiment of the invention start folding in a state in which they are fully unfolded. FIG. 24 is a perspective view illustrating a state in which the main hinge plates and the sub hinge plates coupled to the central joint of the in-folding type hinge structure according to another embodiment of the invention are folded by about 90 degrees. FIG. 25 is a perspective view illustrating a state in which the main hinge plates and the sub hinge plates coupled to the central joint of the in-folding type hinge structure according to another embodiment of the invention are fully folded.

Referring to FIGS. 22 to 25, in the in-folding type hinge structure according to another embodiment of the invention, the central joint 150 are coupled to the main hinge plates 153 and the sub hinge plates 155, and the main hinge plates 153 and the sub hinge plates 155 are coupled to the bottom surface of the panels 112. When the panels perform a folding operation, the main hinge plates 153 and the sub hinge plates 155 are folded with respect to the central joint 150 in the order illustrated in FIGS. 22 to 25.

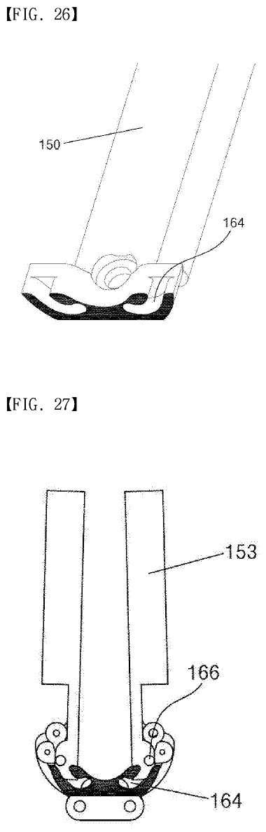

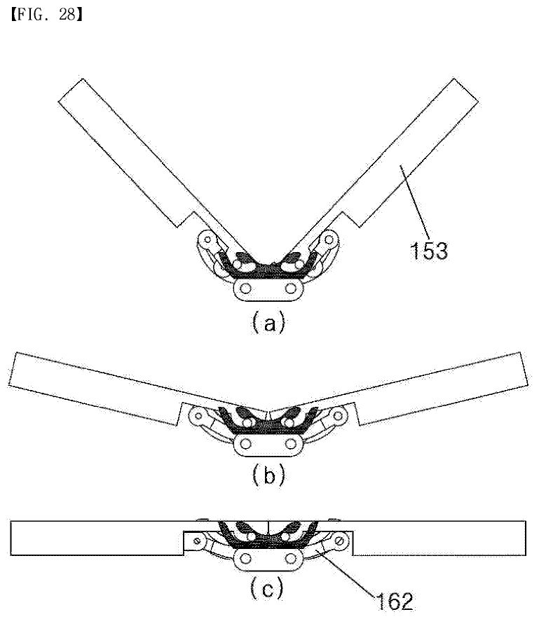

FIG. 26 is a perspective view illustrating the shapes of the rotation guide grooves which are formed in the front surface of the central joint of the in-folding type hinge structure according to another embodiment of the invention. FIG. 27 is a front view illustrating a state in which the rotation guide protrusions of the main hinge plates are inserted into the rotation guide grooves formed in the front surface of the central joint in the state in which the main hinge plates are fully folded at the central joint in the in-folding type hinge structure according to another embodiment of the invention. FIG. 28 is a front view illustrating a state in which the rotation guide protrusions of the main hinge plates move in the rotation guide grooves formed in the front surface of the central joint while the main hinge plates are being unfolded in the in-folding type hinge structure according to another embodiment of the invention.

Referring to FIGS. 26 to 28, according to the invention, the rotation guide protrusions 166 formed in the front part and the rear part of the main hinge plates 153 move along the rotation guide grooves 164 formed in the central joint 150 and the extension mount 152, and the main hinge plates 153 rotate.

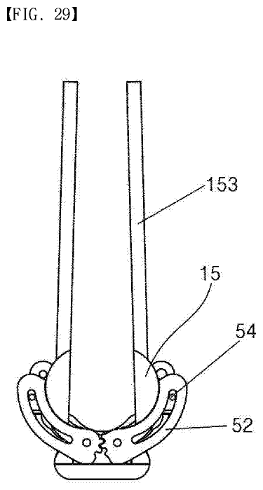

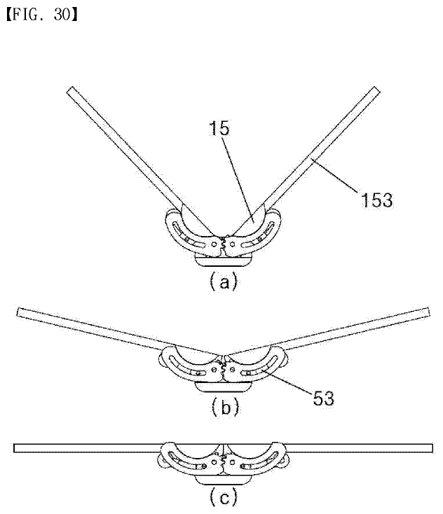

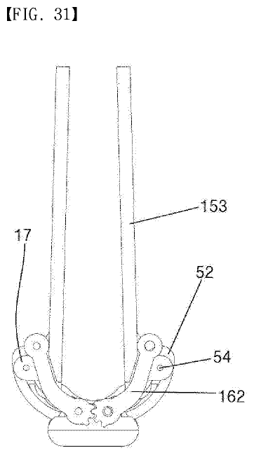

FIG. 29 is a front view illustrating a state in which the rotation supports connected to the central joint support the main hinge plates in the state in which the main hinge plates are fully folded at the central joint in the in-folding type hinge structure according to another embodiment of the invention. FIG. 30 is a front view illustrating a state in which the rotation supports connected to the central joint move while the main hinge plates are being unfolded in the in-folding type hinge structure according to another embodiment of the invention.

Referring to FIGS. 29 and 30, the arc-shaped rotation supports 52 according to the invention rotate along semi-cylindrical contact surfaces 15 which are formed in the main hinge plates 153.

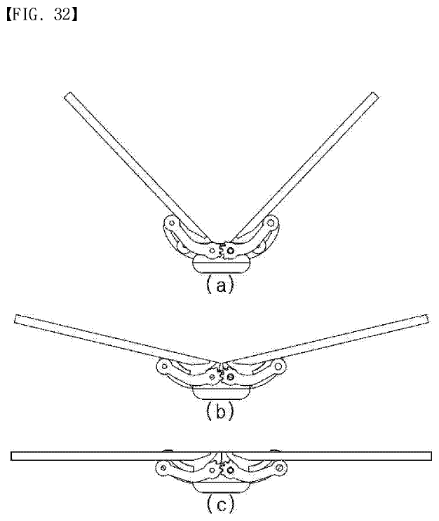

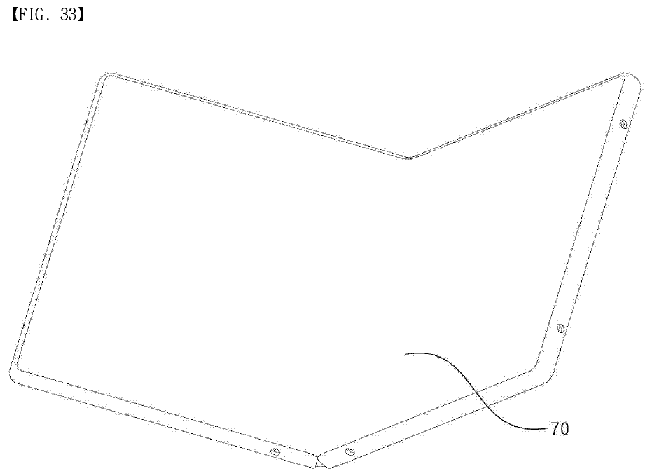

FIG. 31 is a front view illustrating a state in which the symmetric supports connected to the central joint supports the main hinge plates such that the main hinge plates are symmetric in angle in the state in which the main hinge plates are fully folded at the central joint in the in-folding type hinge structure according to another embodiment of the invention. FIG. 32 is a front view illustrating a state in which the symmetric supports connected to the central joint supports the main hinge plates such that the main hinge plates are symmetric in angle while the main hinge plates are being unfolded in the in-folding type hinge structure according to another embodiment of the invention.

Referring to FIGS. 31 and 32, a pair of symmetric supports 162 according to the invention support the panels 112 with the gears engaging with each other such that the panels 112 are folded and unfolded at the same angle when a folding or unfolding operation is performed.

When only the rotation supports 52 are provided, a phenomenon in which the panels coupled to the main hinge plates 153 and the sub hinge plates 155 delaminate may occur when the panels 112 are unfolded or folded. Accordingly, the symmetric supports 162 serve to match rotation angles of the panels 112 with each other such that such a phenomenon is prevented.

FIG. 33 is a perspective view illustrating a state in which a flexible display panel is installed on a top surface of the in-folding type hinge structure having the flexible display panel installed therein according to another embodiment of the invention.

Referring to FIG. 33, a flexible display panel 70 is attached to the top surface of the assembled panels 112 to finally complete an in-folding type smartphone.

### INDUSTRIAL APPLICABILITY

While an exemplary embodiment of the invention has been described above using specific terms, such description is only for explanation and it is obvious that the embodiment can be modified in various forms without departing from the technical spirit and scope of the appended claims. Such modified embodiments should not be understood separately from the spirit and scope of the invention and should belong to the appended claims.

### REFERENCE SIGNS LIST

10, 12: Body portion
17: Rivet fixing portion
19: Guide groove
20: Sliding panel
22: Guide protrusion
40: Polyarticular portion
50: Central joint
52: Rotation support
53: Guide groove
54: Rivet
56: Gap providing portion
70: Flexible display panel

1. An in-folding type hinge structure having a flexible display panel installed therein, comprising:
a panel portion in which the flexible display panel is installed, a joint portion (141) including a plurality of joints are formed in a central part thereof, and panels (112) are installed on both sides of the joint portion (141);
outer cases (110) in which the panels (112) of the panel portion are accommodated; and
sliders (121) that are rotatably coupled to an intermediate part between the panels (112),
wherein the sliders (121) are accommodated in slider accommodation portions (124) in the outer cases and slide while the panels (112) are being folded or unfolded, and
wherein a central joint (150) which is completely assembled is installed at the center of a bottom surface of the panels (112) and is rotatably coupled to the sliders (121) by a connection pin (143).

2. The in-folding type hinge structure having a flexible display panel installed therein according to claim 1, wherein rotation supports (52) and sub hinge plates (155) are rotatably connected to a rear part of the central joint (150) and a first extension mount (151) is installed in a front part thereof,
wherein the rotation supports (52) are connected to the first extension mount to be rotatable with the main hinge plates (153),
wherein symmetric supports (162) are connected to front and rear surfaces of the rotation supports (52),
wherein the rotation supports (52) and the symmetric supports (162) include connecting intermediate portions which are gears engaging with each other and are configured to rotate simultaneously in opposite directions in rotation,
wherein rotation guide grooves (164) are formed in a front part of the central joint (150),
wherein rotation guide protrusions (166) are formed in the main hinge plates (153) and the rotation guide protrusions (166) are inserted into the rotation guide grooves (164) such that the rotation guide protrusions (166) move along the rotation guide grooves (164),
wherein a movement trajectory of the main hinge plates (153) is formed along the rotation guide grooves (164),
wherein rotation guide grooves (164) are formed in a rear surface of a second extension support (152) and rotation guide protrusions (166) formed in a front part of the main hinge plates (153) are inserted into the rotation guide grooves (164) such that the rotation guide protrusions (166) move, and
wherein the rotation supports (52) connected to the sub hinge plates (155) include connecting portions which are gears engaging with each other such that the rotation supports (52) move in the opposite directions at the time of rotation.
